(19) United States
(12) Patent Application Publication
(10) Pub. No.: US 2012/0167019 A1
(43) Pub. Date: Jun. 28, 2012

(54) MASK REVISION RECORDING CIRCUIT FOR A MEMORY CIRCUIT

(76) Inventors: Shi-Huei Liu, Hsinchu County (TW); Yung-Hsing Chen, Hsinchu City (TW); Cheng-Nan Chang, Tainan City (TW)

(21) Appl. No.: 13/048,891

(22) Filed: Mar. 16, 2011

(30) Foreign Application Priority Data
Dec. 22, 2010 (TW) 099145171

(51) Int. Cl. G06F 17/50

(52) U.S. Cl. 716/51

(57) ABSTRACT

A mask revision recording circuit for a memory circuit includes a mask recording module and a reading unit. The mask recording module includes a plurality of mask recording units, and a layout of each mask recording unit corresponds to all masks of a layout of the memory circuit. The reading unit is coupled to the mask recording module for reading information of the mask recording module corresponding to a mask revision of the memory circuit according to a clock and an enable signal.

### BACKGROUND OF THE INVENTION

1. Field of the Invention

The present invention is related to a circuit for recording a mask revision of a memory circuit, and particularly to a circuit that utilizes a mask recording unit to record information of revisions of all masks of a memory circuit.

2. Description of the Prior Art

In the prior art, when a designer of a memory circuit requires recording of information of a mask revision of the memory circuit, the designer usually integrates a mask recording unit into a layout of the memory circuit. The mask recording unit includes layouts of masks that the designer desires to record. When the layout of the memory circuit is revised, the layout of the mask recording unit is also revised. Thus, the designer of the memory circuit can obtain the information of the mask revision of the memory circuit through the mask recording unit.

However, in the prior art, the layout of the mask recording unit does not correspond to all masks of the memory circuit. Therefore, when the layout of the memory circuit is revised, if the mask recording unit does not cover the revised mask of the memory circuit, the designer of the memory circuit needs another method to record the revised mask. To sum up, the mask recording unit of the prior art is not a good choice for the designer of the memory circuit.

### SUMMARY OF THE INVENTION

An embodiment provides a mask revision recording circuit for a memory circuit. The mask revision recording circuit includes a mask recording module and a reading unit. The mask recording module includes a plurality of mask recording units, where a layout of each mask recording unit corresponds to all masks of a layout of the memory circuit. The reading unit is coupled to the mask recording module for reading information of the mask recording module corresponding to a mask revision of the memory circuit according to a clock and an enable signal.

The present invention provides a mask revision recording circuit for a memory circuit. The mask revision recording circuit utilizes a plurality of mask recording units of a mask recording module to record information of mask revisions of the memory circuit, where a layout of each mask recording unit corresponds to the all masks of a layout of the memory circuit, and the layouts of the plurality of mask recording units of the mask recording module are all the same. Therefore, in the present invention, no matter which mask of the layout of the memory circuit is revised, the mask recording module can record the revised mask. In addition, the layouts of the plurality of mask recording units of the mask recording module are all the same, so design complexity of the memory circuit can be reduced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a mask revision recording circuit for a memory circuit according to an embodiment.

FIG. 2 is a diagram illustrating a cross section of the layout of the mask recording unit.

FIG. 3 is a diagram illustrating the mask recording module.

FIG. 4 is a diagram illustrating the reading unit reading the information of the mask recording module corresponding to the mask revision of the memory circuit according to the clock and the enable signal.

### DETAILED DESCRIPTION

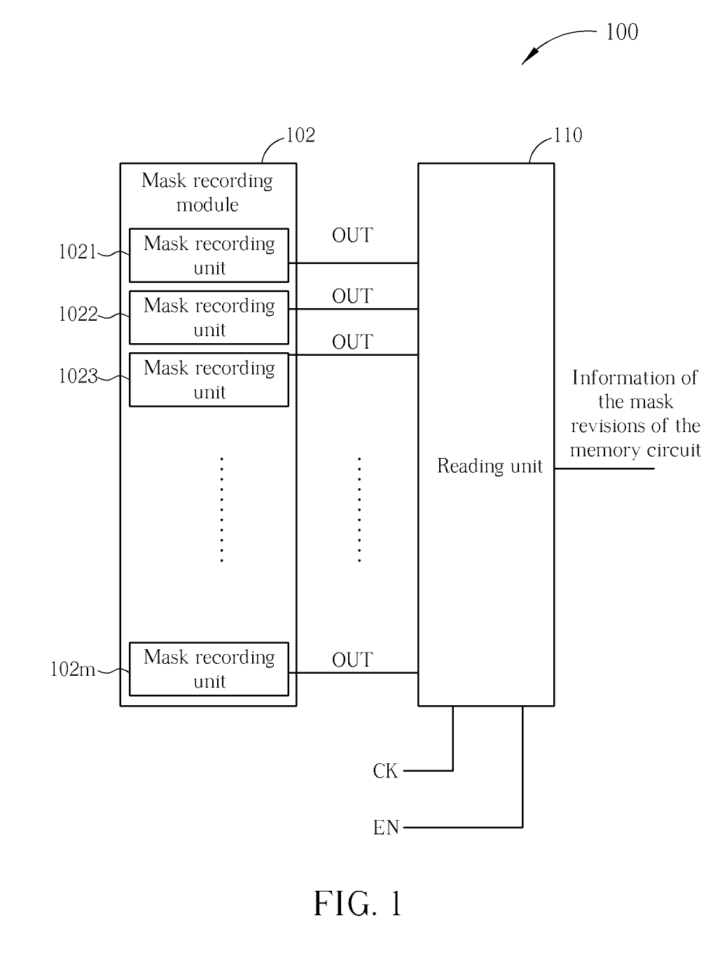

Please refer to FIG. 1. FIG. 1 is a diagram illustrating a mask revision recording circuit 100 for a memory circuit according to an embodiment. The mask revision recording circuit 100 includes a mask recording module 102 and a reading unit 110. The mask recording module 102 includes a plurality of mask recording units 1021-102m, where a layout of each mask recording unit corresponds to all masks of a layout of the memory circuit, and layouts of the plurality of mask recording units 1021-102m are all the same. The reading unit 110 is coupled to the mask recording module 102 for reading information of the mask recording module 102 corresponding to a mask revision of the memory circuit according to a clock CK and an enable signal EN.

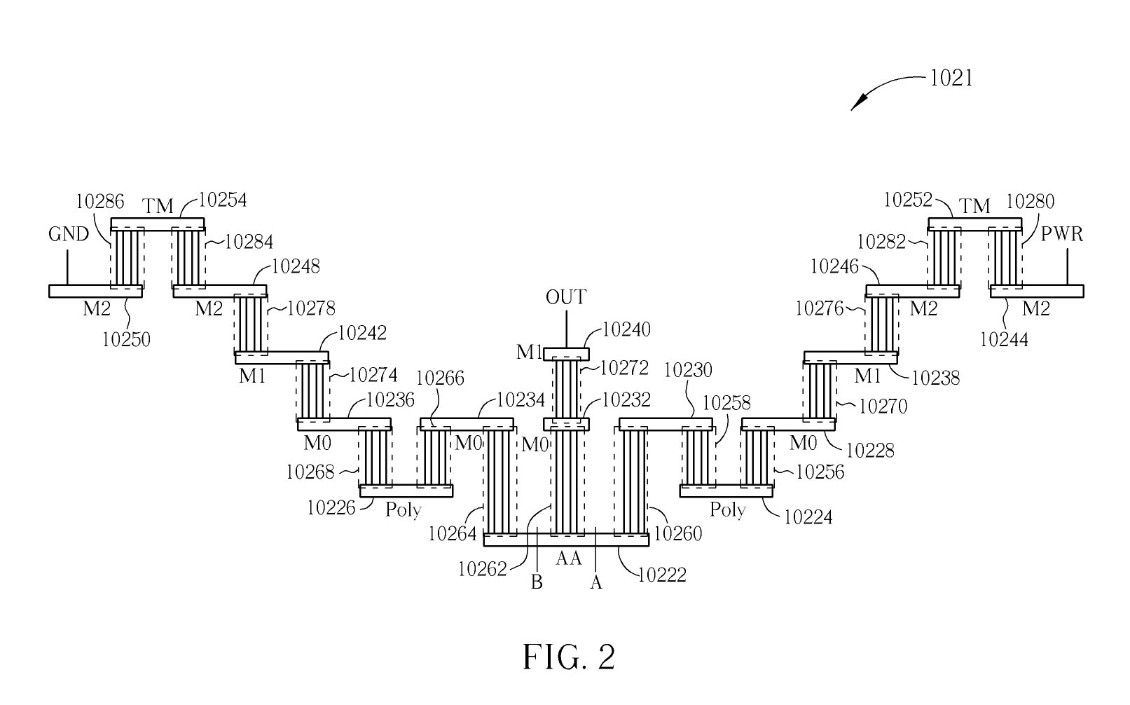

Please refer to FIG. 2. FIG. 2 is a diagram illustrating a cross section of the layout of the mask recording unit 1021. As shown in FIG. 2, the mask recording unit 1021 includes an active area (AA) layer 10222, a first polysilicon (Poly) layer 10224, a second polysilicon layer 10226, a first zeroth metal (M0) layer 10228, a second zeroth metal layer 10230, a third zeroth metal layer 10232, a fourth zeroth metal layer 10234, a fifth zeroth metal layer 10236, a first first metal (M1) layer 10238, a second first metal layer 10240, a third first metal layer 10242, a first second metal (M2) layer 10244, a second second metal layer 10246, a third second metal layer 10248, a fourth second metal layer 10250, a first top metal (TM) layer 10252, a second top metal layer 10254, a first contact (CT) layer 10256, a second contact layer 10258, a third contact layer 10260, a fourth contact layer 10262, a fifth contact layer 10264, a sixth contact layer 10266, a seventh contact layer 10268, a first zeroth via (VIA0) layer 10270, a second zeroth via layer 10272, a third zeroth via layer 10274, a first first via (VIA1) layer 10276, a second first via layer 10278, a first second via (VIA2) layer 10280, a second second via layer 10282, a third second via layer 10284, and a fourth second via layer 10286. The first contact layer 10256 is coupled between the first polysilicon layer 10224 and the first zeroth metal layer 10228, the second contact layer 10258 is coupled between the first polysilicon layer 10224 and the second zeroth metal layer 10230, the third contact layer 10260 is coupled between the active area layer 10222 and the second zeroth metal layer 10230, the fourth contact layer 10262 is coupled between the active area layer 10222 and the third zeroth metal layer 10232, the fifth contact layer 10264 is coupled between the active area layer 10222 and the fourth zeroth metal layer 10234, the sixth contact layer 10266 is coupled between the second polysilicon layer 10226 and the fourth zeroth metal layer 10234, the seventh contact layer 10268 is coupled between the second polysilicon layer 10226 and the fifth zeroth metal layer 10236, the first zeroth via layer 10270 is coupled between the first first metal layer 10238 and the first zeroth metal layer 10228, the second zeroth via layer 10272 is coupled between the second first metal layer 10240 and the third zeroth metal layer 10232, the third zeroth via layer 10274 is coupled between the third first metal layer 10242 and the fifth zeroth metal layer 10236, the first first via layer 10276 is coupled between the second second metal layer 10246 and the first first metal layer 10238, the second first via layer 10278 is coupled between the third first metal layer 10242 and the third second metal layer 10248, the first second via layer 10280 is coupled between the first second metal layer 10244 and the first top metal layer 10252, the second second via layer 10282 is coupled between the second second metal layer 10246 and the first top metal layer 10252, the third second via layer 10284 is coupled between the third second metal layer 10248 and the second top metal layer 10254, and the fourth second via layer 10286 is coupled between the fourth second metal layer 10250 and the second top metal layer 10254. In addition, each mask recording unit of the plurality of mask recording unit 1021-102m has a first terminal for receiving a first voltage PWR, a second terminal coupled to ground GND, and an output terminal OUT coupled to the reading unit 110. As shown in FIG. 2, the fourth second metal layer 10250 is further coupled to the second terminal of the mask recording unit 1021, the second first metal layer 10240 is further coupled to the output terminal OUT of the mask recording unit 1021, and the first second metal layer 10244 is further coupled to the first terminal of the mask recording unit 1021. Further, the active area layer 10222 is an N+ resistor. Because the layouts of the plurality of mask recording units 1021-102m of the mask recording module 102 are all the same, further description of the layout of other mask recording units of the plurality of mask recording units 1022-102m is omitted for simplicity.

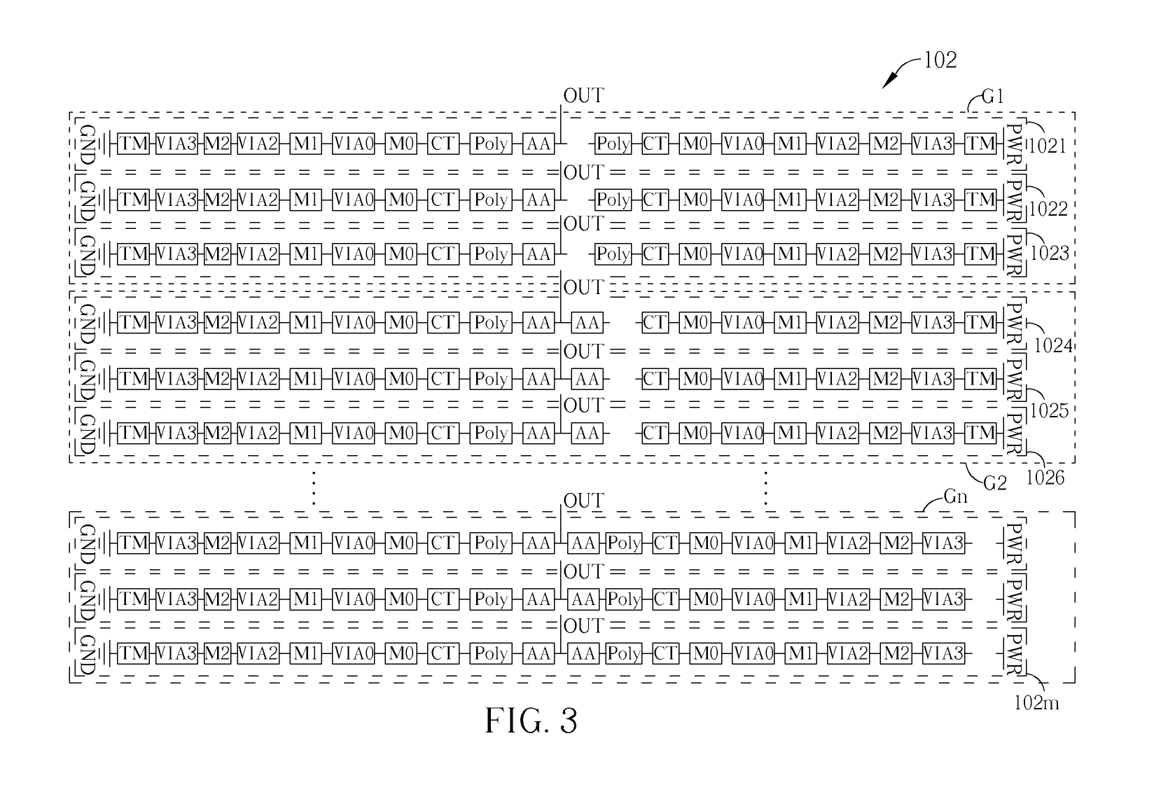

FIG. 3 is a diagram illustrating the mask recording module 102. As shown in FIG. 3, each mask recording unit in FIG. 3 is a bird's eye view of the mask recording unit 1021 in FIG. 2. The plurality of mask recording units 1021-102m are divided into a plurality of groups G1-Gn according to the all masks of the layout of the memory circuit, where each group corresponds to a mask of the memory circuit, and number of mask recording units of each group is the same. For example, the layout of the memory circuit has 10 layer masks, so 30 mask recording units 1021-1050 included by the mask recording module 102 are divided into 10 groups G1-G10, and each group of the 10 groups G1-G10 has 3 mask recording units. Each mask of the memory circuit corresponds to 3 mask recording units, so the mask of the memory circuit can be revised 8 times. As shown in FIG. 3, the mask recording units 1021, 1022, 1023 correspond to an active area layer of the memory circuit, and the mask recording units 1024, 1025, 1026 correspond to a contact layer of the memory circuit, and so on. But the present invention is not limited to the 30 mask recording units and the 10 layer masks, and is also not limited to the mask recording units 1021, 1022, 1023 corresponding to the active area layer of the memory circuit and the mask recording units 1024, 1025, 1026 corresponding to the contact layer of the memory circuit. In addition, the layout of each mask recording unit of the mask recording module 102 covers the all masks of the layout of the memory circuit, and the layout of each mask recording unit of the mask recording module 102 is the same. For example, the layout of the memory circuit has 10 layer masks, so the layout of each mask recording unit of the mask recording unit 1021-102m also has 10 layer masks.

As shown in FIG. 3, a default value of the output terminal of each mask recording unit is a logic-low voltage “0”, (that is, the ground GND). Therefore, the layout of the mask recording unit 1021 for recording a mask revision of the active area layer is cut at point A (shown in FIG. 2), so the output terminal OUT of the mask recording unit 1021 can output the logic-low voltage “0”. If the output terminal OUT of the mask recording unit 1021 outputs a logic-high voltage “1” (that is, the first voltage PWR), the layout of the mask recording unit 1021 is cut at point B (shown in FIG. 2). When the reading unit 110 reads outputs of the mask recording unit 1021, 1022, 1023 are 0, 0, 1, the mask of the active area layer is revised one time; when the reading unit 110 reads outputs of the mask recording unit 1021, 1022, 1023 are 1, 0, 1, the mask of the active area layer is revised five times, and so on. In addition, subsequent operational principles of other mask recording units of the mask recording module 102 are the same as those of the mask recording unit 1021, so further description thereof is omitted for simplicity.

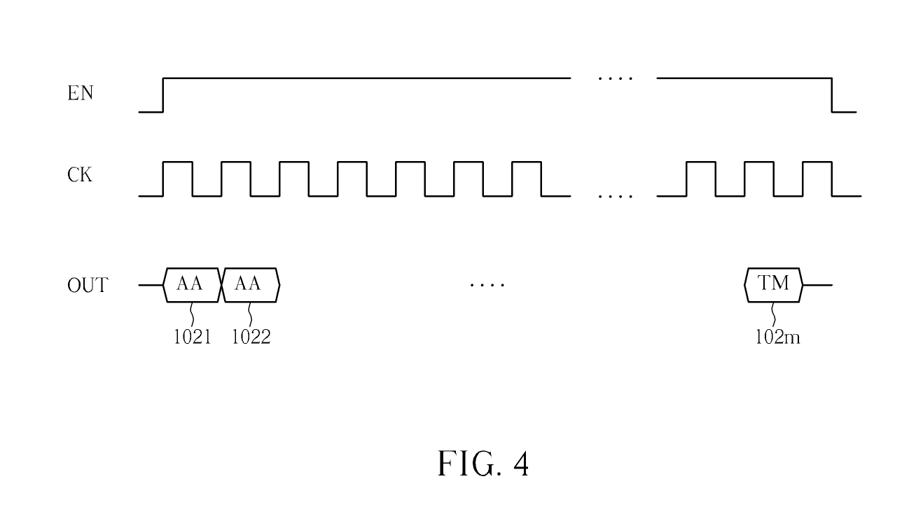

Please refer to FIG. 4. FIG. 4 is a diagram illustrating the reading unit 110 reading the information of the mask recording module 102 corresponding to the mask revision of the memory circuit according to the clock CK and the enable signal EN. As shown in FIG. 4, when the enable signal EN is enabled, the reading unit 110 outputs results recorded by the plurality of mask recording units 1021-102m of the mask recording module 102 in turn according to the clock CK. A designer of the memory circuit can determine the information of the mask revision of the memory circuit according to the results outputted by the reading unit 110. As shown in FIG. 4, the enable signal EN can be kept enabled, so the reading unit 110 can cyclically output the results recorded by the plurality of mask recording units 1021-102m of the mask recording module 102. However, the enable signal EN is also enabled until the results recorded by the plurality of mask recording units 1021-102m of the mask recording module 102 are outputted once.

To sum up, the mask revision recording circuit for the memory circuit utilizes the plurality of mask recording units of the mask recording module to record the information of the mask revisions of the memory circuit, where the layout of each mask recording unit corresponds to the all masks of the layout of the memory circuit, and the layouts of the plurality of mask recording units of the mask recording module are all the same. Therefore, in the present invention, no matter which mask of the layout of the memory circuit is revised, the mask recording module can record the revised mask. In addition, the layouts of the plurality of mask recording units of the mask recording module are all the same, so design complexity of the memory circuit can be reduced.

Those skilled in the art will readily observe that numerous modifications and alterations of the device and method may be made while retaining the teachings of the invention.

What is claimed is:

1. A mask revision recording circuit for a memory circuit, the mask revision recording circuit comprising:
a mask recording module comprising a plurality of mask recording units, wherein a layout of each mask recording unit corresponds to all masks of a layout of the memory circuit; and
a reading unit coupled to the mask recording module for reading information of the mask recording module corresponding to a mask revision of the memory circuit according to a clock and an enable signal.

2. The mask revision recording circuit of claim 1, wherein the mask recording unit has a first terminal for receiving a first voltage, a second terminal coupled to ground, and an output terminal coupled to the reading unit.

3. The mask revision recording circuit of claim 1, wherein the mask recording unit comprises:
an active area (AA) layer;
a first polysilicon (Poly) layer;
a second polysilicon layer;
a first zeroth metal (M0) layer;
a second zeroth metal layer;
a third zeroth metal layer;
a fourth zeroth metal layer;
a fifth zeroth metal layer;
a first first metal (M1) layer;
a second first metal layer;
a third first metal layer;
a first second metal (M2) layer;
a second second metal layer;
a third second metal layer;
a fourth second metal layer;
a first top metal (TM) layer;
a second top metal layer;
a first contact (CT) layer coupled between the first polysilicon layer and the first zeroth metal layer;
a second contact layer coupled between the first polysilicon layer and the second zeroth metal layer;
a third contact layer coupled between the active area layer and the second zeroth metal layer;
a fourth contact layer coupled between the active area layer and the third zeroth metal layer;
a fifth contact layer coupled between the active area layer and the fourth zeroth metal layer;
a sixth contact layer coupled between the second polysilicon layer and the fourth zeroth metal layer;
a seventh contact layer coupled between the second polysilicon layer and the fifth zeroth metal layer;
a first zeroth via (VIA0) layer coupled between the first first metal layer and the first zeroth metal layer;
a second zeroth via layer coupled between the second first metal layer and the third zeroth metal layer;
a third zeroth via layer coupled between the third first metal layer and the fifth zeroth metal layer;
a first first via (VIA1) layer coupled between the second second metal layer and the first first metal layer;
a second first via layer coupled between the third first metal layer and the third second metal layer;
a first second via (VIA2) layer coupled between the first second metal layer and the first top metal layer;
a second second via layer coupled between the second second metal layer and the first top metal layer;
a third second via layer coupled between the third second metal layer and the second top metal layer; and
a fourth second via layer coupled between the fourth second metal layer and the second top metal layer;
wherein the fourth second metal layer is further coupled to the second terminal of the mask recording unit, the second first metal layer is further coupled to the output terminal of the mask recording unit, and the first second metal layer is further coupled to the first terminal of the mask recording unit.

4. The mask revision recording circuit of claim 3, wherein the active area layer is an N+ resistor.

5. The mask revision recording circuit of claim 1, wherein layouts of the plurality of mask recording units are all the same.
